(19) United States
(12) Patent Application Publication
(10) Pub. No.: US 2026/0133152 A1
(43) Pub. Date: May 14, 2026

(54) MULTI VOLTMETER COMPLEX DIELECTRIC SENSOR

(71) Applicant: METER Group, Inc., Pullman, WA (US)

(72) Inventors: Paolo Castiglione, Pullman, WA (US); Gaylon S. Campbell, Pullman, WA (US)

(21) Appl. No.: 19/221,337

(22) Filed: May 28, 2025

Related U.S. Application Data
(60) Provisional application No. 63/717,963, filed on Nov. 8, 2024.

(51) Int. Cl. G01N 27/02; G01N 27/22

(52) U.S. Cl. CPC G01N 27/028; G01N 27/221

(57) ABSTRACT

A complex dielectric sensor measures the electric admittance of a set of electrodes in contact with the sample material. From four voltage amplitude measurements, it possible to obtain three independent estimates of sample admittance. The weighted average of said three estimates yields a more accurate and more robust estimate of admittance, compared to previous methods. From the admittance, one can predict the complex permittivity of the sample material through a suitable model for the electrodes. The availability of three independent estimates of sample admittance also permits calibrating the circuit parameters without reference standards. Moreover, the sensor can be diagnosed remotely, and its accuracy can be verified irrespective of the sample material with which the sensor is in contact.

### CROSS-REFERENCE TO RELATED APPLICATIONS

This claims the benefit of, and priority to, U.S. Provisional Patent Application No. 63/717,963, filed 8 Nov. 2024, the entire disclosure of which is hereby incorporated by reference.

### TECHNICAL FIELD

The present disclosure generally relates to sensors and equipment for measuring the electrical properties of materials.

### BACKGROUND

The electrical properties of materials, namely dielectric permittivity (ε) and electrical conductivity (σ), are of interest in a wide variety of applications (e.g. agriculture, food science, etc.). For example, in porous media such as soil, ε is strongly correlated with water content, and dielectric sensors are routinely employed to measure soil moisture. Also, the solute concentration of the water phase impacts the electric conductivity of soil. Thus, σ measurements are performed to monitor nutrient concentration in precision agriculture.

The two properties can be combined to form the complex permittivity (η), defined as:

$$η = ε - i \frac{σ}{ω {ε}_{0}} \qquad ( 1 )$$

where i=\sqrt{−1}, ω is the angular frequency, and ε₀ is the absolute permittivity in free space. The complex permittivity η accounts for polarization and conduction processes (respectively through ε and σ) and therefore fully describes the response of matter to an electromagnetic field. In particular, the permittivity of a sample material determines the electric admittance (Y_{S}) of a system of electrodes embedded in it. From measurements of Y_{S}, therefore, one can estimate n. According to eq. (1), this is equivalent to measuring both ε and σ at once, as they are independently obtained from the real and imaginary part of η. Since η and Y_{S} are complex quantities, sensors which operate on this principle are referred to as complex dielectric sensors. As used herein, complex permittivity is also referred to simply as “permittivity.”

One technique for measuring admittance (or its reciprocal, impedance) is the so-called three-voltmeter method (3VM) (e.g., Marzetta, Louis A. 1972. “An Evaluation of the Three-Voltmeter Method for AC Power Measurement.” IEEE Transactions on Instrumentation and Measurement 21 (4): 353-57. available at https://doi.org/10.1109/TIM.1972.4314042; Callegaro, L., G. Galzerano, and C. Svelto. 2003. “Precision Impedance Measurements by the Three-Voltage Method with a Novel High-Stability Multiphase DDS Generator.” IEEE Transactions on Instrumentation and Measurement 52 (4): 1195-99. available at https://doi.org/10.1109/TIM.2003.815990; and Muciek, Andrzej, and Franco Cabiati. 2006. “Analysis of a Three-Voltmeter Measurement Method Designed for Low-Frequency Impedance Comparisons.” Metrology and Measurement Systems 13 (1): 19-31, the entire disclosures of each of which are hereby incorporated by reference). This method relies on measurement of voltage amplitude at three nodes in the measuring circuit. The main advantage relative to traditional methods, which rely on vector, or phasor voltmeters (i.e. on measurements of both amplitude and phase of voltage signals), is that amplitude, or root mean square (RMS), voltmeters are typically more accurate and less expensive. Complex dielectric sensors based on the 3VM have been discussed in the literature (e.g. U.S. Pat. No. 5,479,104, issued 26 Dec. 1995; U.S. Pat. No. 10,191,184, issued 29 Jan. 2019; and U.S. Pat. No. 11,415,612, issued 16 Aug. 2022, the disclosures of which are all hereby incorporated by reference in their entireties) and successfully employed as soil moisture sensors.

While the 3VM permits accurate measurements with simple electronics, good accuracy is typically confined to a narrow range of admittance (hence permittivity) values. Away from this range, accuracy declines rapidly, and measurements may not be possible at all for some Y_{S} values (degenerate points). This is at odds with the wide ranges of possible ε and σ values met in most applications. In soil, for example, ε spans nearly two decades from dry to the wet range, and σ can easily span three orders of magnitude.

Another drawback of the 3VM is that calibrating sensors can be difficult and costly. Calculations to predict complex permittivity from voltage measurements, involve numerous parameters. These are typically determined empirically, i.e. through calibration. In a nutshell, the sensor is tested in different standard materials of known reference permittivity. The parameters are then iteratively adjusted (optimized) until the difference between calculated and reference values is minimized. This conceptually simple process can become very difficult when the number of parameters to be optimized is large (say, greater than 5). Such is typically the case for sensors based on the 3VM.

First, optimizing large numbers of parameters can be computationally very challenging. Among other problems, the function to be minimized (the objective function) displays many local minima, and it is extremely easy to obtain meaningless results. Second, the number of standard materials must be greater than the number of parameters one wishes to optimize. This poses a practical challenge, for standard dielectric materials are very hard to come by. Besides air and water, in fact, there are few materials whose dielectric is known and are also safe to handle. Options are even fewer for conductive standards. Moreover, since permittivity is temperature dependent, tests should be performed under carefully controlled conditions, e.g. using thermal baths. As a result, the calibration process is typically tedious, costly, and not always feasible.

There is a growing interest for complex dielectric measurements in the low-cost sensors industry, and a strong push for innovation. Current techniques, such as the three-voltmeter method, although sound, suffer from several drawbacks. Calibration costs and limited accuracy are concerning, as observed, and new techniques, which could address these problems, are highly desirable.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1a is a perspective view of a complex dielectric sensor with two cylindrical electrodes.

FIG. 1b is a perspective view of a complex dielectric sensor with three cylindrical electrodes.

FIG. 1c is a perspective view of a complex dielectric sensor with two planar electrodes.

FIG. 1d is a perspective view of a complex dielectric sensor with two ring-shaped electrodes mounted on a shaft.

FIG. 2 is a circuit diagram representing a generic voltage divider.

FIG. 3a is a circuit diagram representing a possible embodiment of the 3VM, where two voltage dividers are obtained by means of a set of switches.

FIG. 3b is a circuit diagram representing another possible embodiment of the 3VM, where voltage measurements at three nodes yield two voltage ratios, thus two voltage dividers.

FIG. 4 is a plot representing the geometrical interpretation of the 3VM. The sample admittance (Y_{S}) is found from the intersection of two circles in the admittance plane.

FIG. 5a is a plot representing the geometrical interpretation of the 3VM for a degenerate case, where the two circles are tangent at one point. In this case, small errors in radii (as in the dash-line circle) result in large errors in the real part of Y_{S}.

FIG. 5b is a plot representing the geometrical interpretation of the 3VM for another degenerate case, where the two circles are tangent at one point. In this case, small errors in radii (as in the dash-line circle) result in large errors in the imaginary part of Y_{S}.

FIG. 6a is a circuit diagram representing an example embodiment of the 4VM wherein voltage measurements at two nodes yield three voltage ratios, and thus three voltage dividers.

FIG. 6b is a circuit diagram representing another possible embodiment of the 4VM wherein voltage measurements at four nodes yield three voltage ratios, and thus three voltage dividers.

FIG. 7a is a plot representing the geometrical interpretation of the 4VM. The sample admittance Y_{S} is found from the intersection of three circles in the admittance plane.

FIG. 7b is a plot representing the intersection of three slightly incorrect circles in the admittance plane. In this case, the three circles intersect in three distinct points, each representing an approximate estimate of the true sample admittance.

FIG. 8 is a flow chart showing the calculations involved in estimating complex permittivity from four measured voltage measurements.

FIG. 9a is a circuit diagram representing a possible embodiment of the 3VM, where a resistor R and a capacitor C are connected in series with the sample of admittance Y_{S}.

FIG. 9b is a circuit diagram representing a possible embodiment of the 4VM, with a resistor R, an inductor L, and a capacitor C connected in series with the sample of admittance Y_{S}.

FIG. 10a is a plot of complex permittivity values estimated in a numerical experiment by the 3VM circuit in FIG. 9a, when a random error of +/−1 mV is introduced in the voltage data.

FIG. 10b is a plot of complex permittivity values estimated by the 4VM circuit in FIG. 9b when a random error of +/−1 mV is introduced in the voltage data. The errors are much smaller than for the 3VM in FIG. 10a.

FIG. 10c is a plot of the dielectric errors observed for the 3VM.

FIG. 10d is a plot of the dielectric errors observed for the 4VM.

FIG. 10e is a plot of the conductivity errors observed for the 3VM.

FIG. 10f is a plot of the conductivity errors observed for the 4VM.

FIG. 11a is a plot of the sample admittance predicted for several samples using the incorrect centers for the circles. The three independent estimates obtained for each sample, do not coincide in this case.

FIG. 11b is a plot of the same data as in FIG. 10a, once the correct values for the centers (fit centers) are found by imposing that the three estimates of admittance coincide for all samples.

FIG. 12a is a plot illustrating the geometrical interpretation of the method to estimate the internal resistance.

FIG. 12b is a plot of the errors in internal resistance estimates observed for 20 4VM sensors in different water solutions. The reference value is 60Ω, so the error in this case is less than 0.2%.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

### Sample Admittance

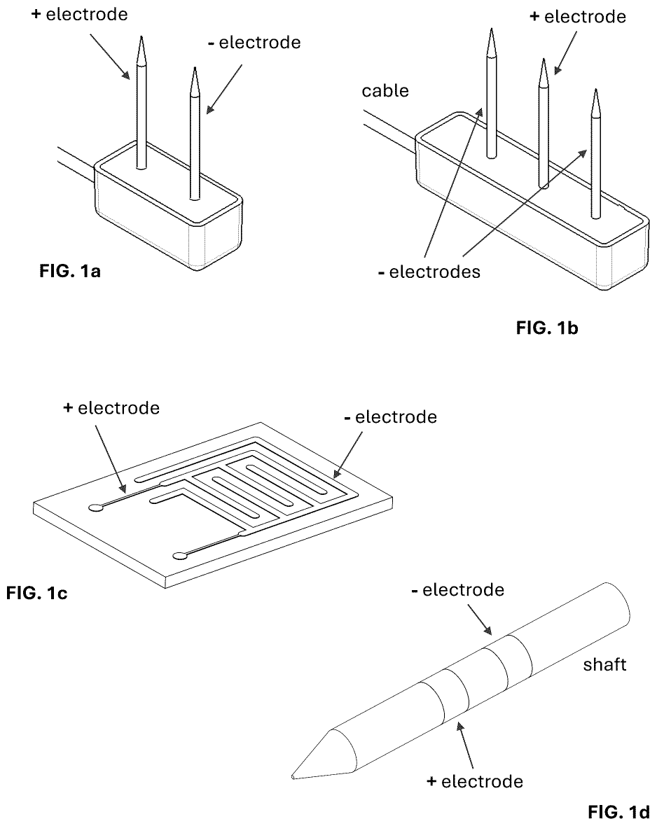

Embodiments of the complex dielectric sensor herein disclosed may rely on a set of electrodes put in contact or in proximity with a sample material. The size, number and geometry of the electrodes may vary, depending on the application. For example, FIGS. 1a-1d illustrate four possible configurations. In FIGS. 1a and 1b, the electrodes are cylindrical metal rods, which can be inserted firmly into the sample material. The electrodes are kept at different potentials (voltages) to produce an electric field in the space between them. Therefore, at least two electrodes may be included to generate the electric field (as in FIG. 1a). Configurations with multiple electrodes are possible, as in FIG. 1b, where the central electrode may be excited (+ electrode), while the two lateral electrodes are kept at zero potential (− electrodes). FIG. 1c depicts a planar geometry for a pair of electrodes, which may be placed in proximity or in contact with the sample. FIG. 1d shows two ring-shaped electrodes mounted on a cylindrical shaft, which can be inserted into a sample. In this case, the electric field is shaped as toroid and therefore penetrates the surrounding material.

The set of electrodes forms a one-port network, whose electrical admittance, which is herein referred to as sample admittance (Y_{S}), depends on the geometry of the electrodes, frequency, and on the complex permittivity of the surrounding material (η). If such dependance is known for a specific configuration, complex permittivity (η) can be estimated from measurements of sample admittance (Y_{S}).

Obtaining an accurate model for the sample admittance is a fundamental and non-trivial aspect of dielectric measurements. At low frequencies (i.e. for wavelengths much larger than the electrodes) all configurations can be represented as a capacitance and a conductance in parallel. In this case the relation between Y_{S} and η is linear, and reads:

$${Y}_{S} = i ω {C}_{0} η \qquad ( 2 )$$

where C₀ is a geometric constant. At high frequencies, however (such as those met in moisture measurements, around 100 MHz), self-inductance emerges, and more sophisticated models are required. Here different configurations may display different electric behavior. For example, two parallel cylinders (as in FIG. 1a) may form a transmission line. The sample admittance in this case is described by:

$${Y}_{S} = {C}_{0} \frac{c}{l} \sqrt{η} tanh ( i ω \frac{l}{c} \sqrt{η} ) \qquad ( 3 )$$

where c is the speed of light in free space, and l is length of the electrodes. While not as elementary as the eq. 2, the eq. 3 can be solved for η once Y_{S} is measured. Note how eq. 3 reduces to eq. 2 for low frequencies, or for short electrodes.

The present disclosure relates, in part, to methods to measure the sample admittance Y_{S}. It will be assumed that a model relating Y_{S} and η is available for the specific configuration at hand, and that such model is exact. Therefore, the accuracy of the estimated permittivity is determined by the accuracy of Y_{S} measurements.

### Three-Voltmeter Method

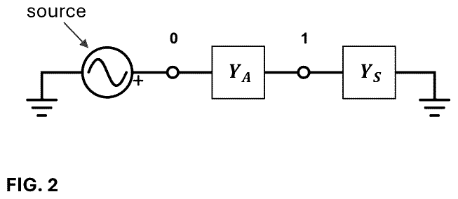

FIG. 2 depicts a simple voltage divider (VD). This simple circuit is central to various embodiments disclosed herein. The unknown admittance Y_{S} is connected in series with a passive component (resistor, capacitor, or inductor), whose admittance Y_{A} is known. The circuit is excited with a sinusoidal voltage signal at node 0, while voltage amplitude is measured at nodes 0 and 1 by means of generic RMS voltmeters (not shown). The relation between the two amplitudes is derived from network analysis, and reads:

$$\frac{\vert {V}_{1} \vert}{\vert {V}_{0} \vert} = \frac{\vert {Y}_{A} \vert}{\vert {Y}_{S} + {Y}_{A} \vert} \qquad ( 4 )$$

Here V₀ and V₁ are complex quantities (phasors), while their absolute values denote their amplitudes. In the following, eq. 4 will be referred to as a voltage divider equation (VDE).

Clearly, eq. 4 is not sufficient to estimate complex Y_{S} from measurements of voltage ratio |V₁|/|V₀|. It is, in fact, one equation in two unknowns (the real and the imaginary part of Y_{S}). When using two voltage dividers, however, two VDEs become available, and thus a unique solution for Y_{S} may be found. Since it takes at least three voltage measurements to obtain two independent voltage ratios (that is, two VDs), this is known as three-voltmeter method (3VM).

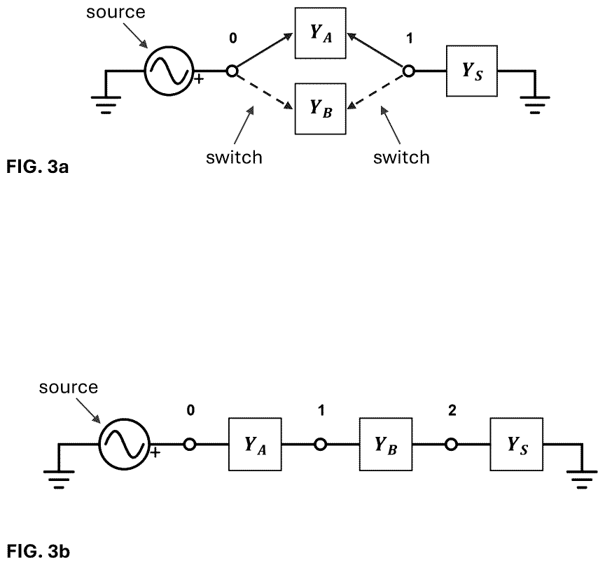

Two voltage dividers may be realized in several ways. FIGS. 3a-3b shows two possible configurations. In FIG. 3a, unknown Y_{S} is connected alternatively to reference component Y_{A} and Y_{B} by means of switches, thus effectively forming two VDs. An alternative configuration, which avoids the use of switches, is shown in FIG. 3b. Here Y_{A}, Y_{B}, and Y_{S} are connected in series. Two voltage dividers can be identified, for example, from the ratios between voltages at nodes 2 and 1, and at nodes 2 and 0. The corresponding VDEs are respectively:

$$\frac{\vert {V}_{2} \vert}{\vert {V}_{1} \vert} = \frac{\vert {Y}_{12} \vert}{\vert {Y}_{S} + {Y}_{12} \vert} \qquad ( 5 )$$

$$\frac{\vert {V}_{2} \vert}{\vert {V}_{0} \vert} = \frac{\vert {Y}_{02} \vert}{\vert {Y}_{S} + {Y}_{02} \vert} \qquad ( 6 )$$

where Y₁₂ is the admittance between nodes 1 and 2 (equal to Y_{B}), and Y₀₂ is the admittance between nodes 0 and 2.

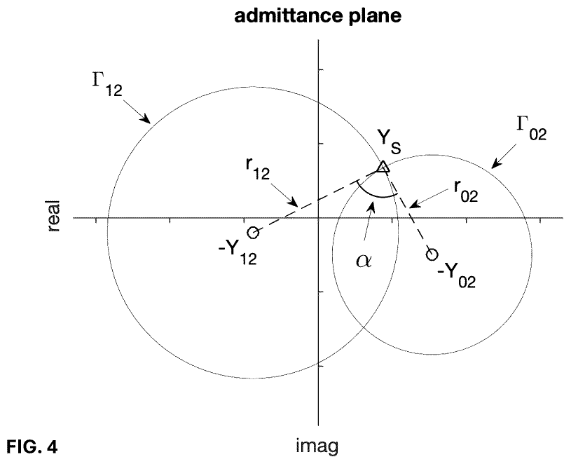

The system of equations 5 and 6 can be solved for Y_{S} through algebra. This may be a simple task only for a few ideal configurations, e.g. when the two reference components are both resistive or both reactive. A geometrical interpretation of the 3VM (e.g., as in Castiglione, Paolo, Gaylon S. Campbell, Aaron Parker, and Agnelo Silva. 2019. “A Complex Dielectric Sensor for Measurement of Water Content and Salinity in Porous Media.” In, 280-85. IEEE. available at https://doi.org/10.1109/MetroAgriFor.2019.8909271, the entire disclosure of which is hereby incorporated by reference) offers an alternative approach, which permits to solve any three voltmeter problem and does not require an analytical solution to said system. It can be shown that the (infinite) solutions to one VDE describe a circle in the complex admittance plane. For example, FIG. 4 shows two such circles, indicated as Γ₁₂ and Γ₀₂, which correspond respectively to equations 5 and 6. The solution common to both equations is evidently found from the intersection of the two circles (two circles intersect in two points, in fact, but it is always possible to identify and disregard the non-physical solution).

The centers of the two circles are set by the reference components (−Y₁₂ for σ₁₂, and −Y₀₂ for Γ₀₂), whereas the radii r₁₂ and r₀₂ are calculated from the corresponding voltage ratios. Therefore, once the circuit is characterized (i.e., the centers are known) from three voltage measurements (hence two ratios), two circles can be drawn in the admittance plane, and Y_{S} can be found very simply from their intersection.

Circuits in practice are not perfectly characterized, and voltmeters are noisy and otherwise non-ideal. Therefore, the accuracy of the 3VM depends in large part on the impact that small, inevitable errors in centers and radii estimates may have on Y_{S} measurements. In other words, on its sensitivity to raw measurements errors. Such sensitivity may vary considerably for different Y_{S} points, and sufficiently small values may be attained only in a relatively small region of the admittance plane. Moreover, for every 3VM device, there are Y_{S} points where the impact is so high that measurements are hardly possible. Such is the case when the two circles are tangent, i.e. intersect in only one point.

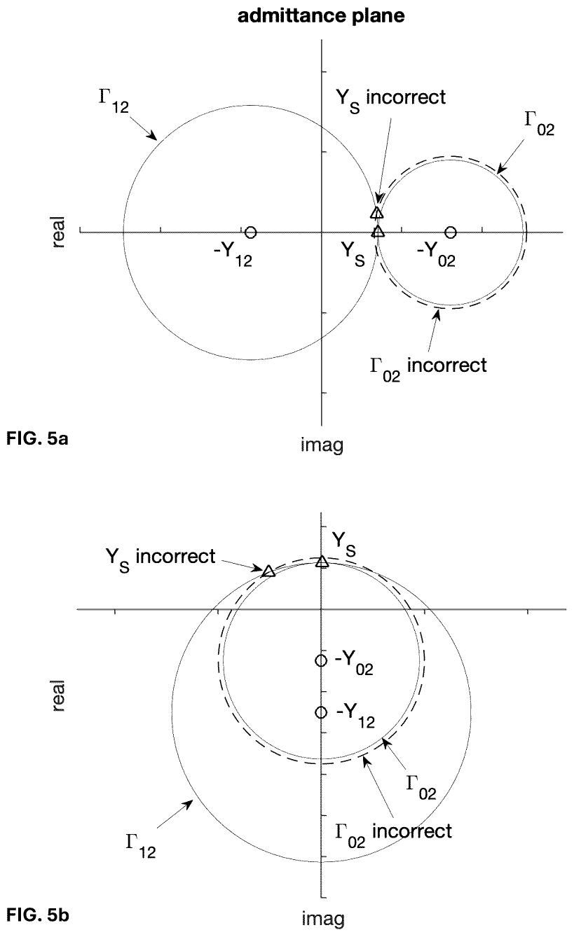

Examples of such degenerate cases are shown in FIGS. 5a-5b. In both cases, the sample admittance is aligned with the two centers, hence the two circles are tangent in one point. In FIG. 5a, centers and Y_{S} lay on the imaginary axis (they are all reactive), whereas they lay on the real axis in FIG. 5b (all resistive). Besides the exact circles, and for sake of example, FIGS. 5a-5b also display an additional circle with dash line, labeled as Γ₀₂ incorrect, which results from overestimating the corresponding radius by 5%. Using the incorrect circles, one obtains incorrect intersections, which depart considerably from the true Y_{S} point. In FIG. 5a, the error is large for the vertical component of Y_{S} (real part), whereas the horizontal component (imaginary part) is especially affected in FIG. 5b. In both cases, a small error in radius value (for example, from incorrect voltage measurements) may result in very large errors in Y_{S}. Such high sensitivity is observed for sample admittance values which are aligned with the two centers (which result in tangent circles). Complex dielectric measurements become unreliable in this case.

In contrast, sensitivity to raw measurements errors is much smaller for the case depicted in FIG. 4, where the two circles are nearly orthogonal at the intersection. Therefore, the angle α between the two radii may offer a measure of the sensitivity at a particular point. The sensitivity is the lowest when the angle is at 90 degrees (approximatively, as in FIG. 4), and the highest for angles approaching 0 or 180 degrees (respectively as in FIGS. 5b and 5a). It is easy to visualize how, for a given 3VM configuration, the angle α can be kept within acceptable values only in a relatively small region of the admittance plane. This limits the range of permittivity values that can be measured accurately with the three-voltmeter method.

### Four-Voltmeter Method

This and other limitations can be overcome by using more than two voltage dividers (as in the 3VM). That is, more VDs than strictly necessary to determine complex Y_{S}. As further explained below, the extra information can be put to good use to significantly improve the performance of the sensor. The methods and concepts herein disclosed can be extended to any number of VDs. At least one embodiment disclosed herein will focus on a configuration with three VDs. As compared with other solutions, using three VDs represents a compromise between enhanced performance and circuit complexity. Since at least four voltage measurements are required to obtain three independent voltage ratios (that is, three VDs), this method is herein referred to as the four-voltmeter method (4VM).

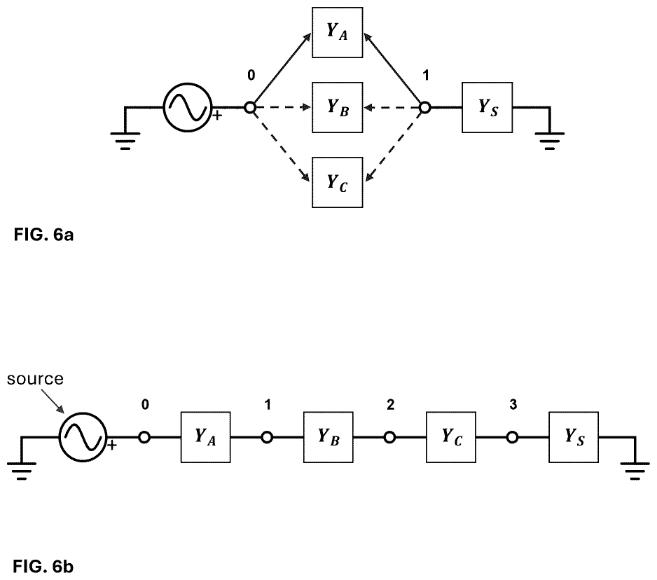

Just as observed earlier with the 3VM, three VDs can be realized with different circuits. For example, a possible embodiment of the 4VM is shown in FIG. 6a, wherein three passive reference components of known admittance Y_{A}, Y_{B}, and Y_{C}, are alternatively connected to the sample admittance Y_{S}, as well as to the voltage source, by means of switches. For each position of the switches, voltage amplitude is measured at nodes 0 and 1. Therefore, three voltage ratios (V₀/V₁) are measured, one for each position of the switches, and three independent voltage dividers can be identified, each corresponding to a respective reference component.

An alternative configuration is shown in FIG. 6b. Here, three reference passive components, or combinations of components, of known admittance Y_{A}, Y_{B}, and Y_{C}, are connected in series among themselves, and with a sample of unknown admittance Y_{S}. A sinusoidal voltage source is applied at node 0, while voltage amplitude is measured at nodes 0, 1, 2, and 3. Three VDs can be identified, for example, from the ratios between voltages at nodes 2 and 3, nodes 1 and 3, and nodes 0 and 3.

The examples illustrated in FIGS. 6a-6b are not exhaustive of the numerous possible configurations that can realize three voltage dividers. For example, additional reference components may be included, as well as multiple voltage sources. Each configuration has its own advantages and disadvantages, and its suitability is typically determined by the specific application and range of measurands. The methods described in the present disclosure are valid and applicable to any device featuring three voltage dividers. For sake of exposition, the results below are derived for the embodiment illustrated in FIG. 6b. Such results can be applied to different configurations (e.g. the one in FIG. 6a) with minor and obvious adaptations, without departing from the spirit of the invention.

With reference to FIG. 6b, from four voltage measurements at nodes 0, 1, 2, and 3, one obtains three independent voltage ratios (V₀/V₃, V₁/V₃, and V₂/V₃). The corresponding VDEs are written below. These are equivalent to eq. 5 or 6, just rearranged, so to make the radii explicit.

$${r}_{23} = \frac{\vert {V}_{2} \vert}{\vert {V}_{3} \vert} \vert {Y}_{23} \vert = \vert {Y}_{S} + {Y}_{23} \vert \qquad ( 7 )$$

$${r}_{13} = \frac{\vert {V}_{1} \vert}{\vert {V}_{3} \vert} \vert {Y}_{13} \vert = \vert {Y}_{S} + {Y}_{13} \vert \qquad ( 8 )$$

$${r}_{03} = \frac{\vert {V}_{0} \vert}{\vert {V}_{3} \vert} \vert {Y}_{03} \vert = \vert {Y}_{S} + {Y}_{03} \vert \qquad ( 9 )$$

Here Y₂₃=Y_{C}, Y₁₃ is the admittance between nodes 1 and 3, and Y₀₃ is the admittance between nodes 0 and 3.

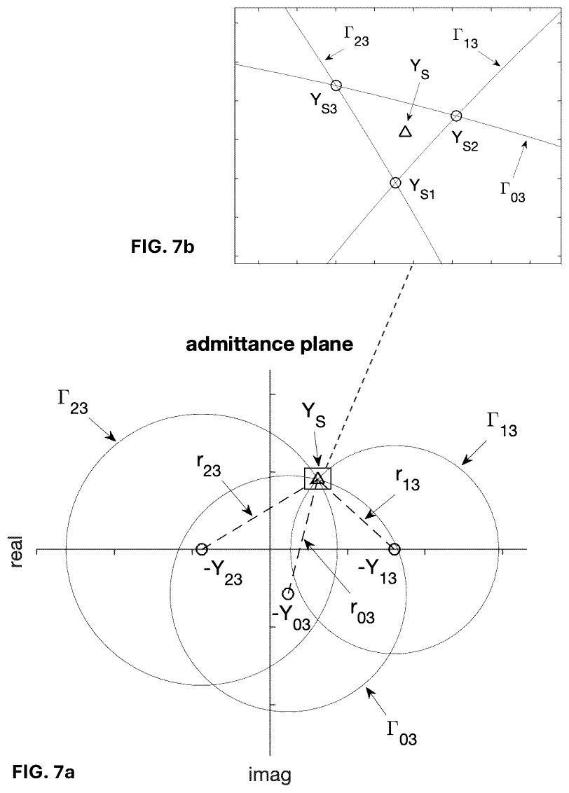

Resorting again to the geometrical interpretation of the voltage divider, the three VDEs above correspond to three circles in the admittance plane. These are illustrated in FIG. 7a, where circles labelled as Γ₂₃, Γ₁₃, and Γ₀₃ correspond respectively to eq. 7, 8, and 9. An intersection can be found between any two circles among the available three. This is equivalent to solving the two corresponding VDEs for Y_{S}. There are three possible pairs of circles among three. Hence, three independent intersections (or solutions of pairs of VDEs) are available with the 4VM. These are independent estimates of sample admittance and will be indicated herein as Y_{S1}, Y_{S2}, and Y_{S3}. They are, respectively, the intersection between circles Γ₂₃ and Γ₁₃, between Γ₁₃ and Γ₀₃, and between Γ₂₃ and Γ₀₃.

It may appear, from FIG. 7a, that the three circles would intersect in the same point (the sought Y_{S} value), and that the three estimates Y_{S1}, Y_{S2}, and Y_{S3} should be identical. This would be the case if all radii and centers were known exactly. In real sensors, however, due to uncertainty in the values of reference components and/or voltage ratios, the three intersections are distinct, in general, and differ from the true Y_{S} value we seek to determine. This is illustrated in the closeup plot in FIG. 7b, where three close, but distinct intersections (Y_{S1}, Y_{S2}, and Y_{S3}) approximate the true Y_{S} value.

Uncorrelated errors in the three estimates (e.g. from noisy voltmeters) tend to cancel each other. Therefore, a more accurate and robust estimate of sample admittance can be obtained by taking the average of Y_{S1}, Y_{S2}, and Y_{S3} than would be possible from each individual intersection. Note that this is not an option with the 3VM, since only one estimate is available (the one intersection in FIG. 4), and there is no way to detect, nor to account for eventual errors.

Accuracy may be further improved by accounting for the different sensitivity to errors displayed by the different estimates. For example, one intersection may be degenerate (i.e., with very large uncertainty). Such estimate is expected to be less accurate than the other two and may be disregarded. This may be accomplished by assigning a weight (w) to each intersection, and estimating Y_{S} from the weighted average:

$${Y}_{S} = {w}_{1} {Y}_{S 1} = {w}_{2} {Y}_{S 2} + {w}_{3} {Y}_{S 3} \qquad ( 10 )$$

where w₁+w₂+w₃=1. Degenerate intersections would then have very little weight compared to the other two.

Each weight is inversely proportional to the sensitivity to measurements errors of the corresponding intersection. Such sensitivity can be calculated for a specific configuration by obtaining an analytical solution for the estimate and differentiating with respect to each of the dependent variables. Considering for example Y_{S1} (solution of eqs. 7 and 8), and assuming for simplicity that errors result only from radii r₂₃ and r₁₃, the following expression holds for the total error, dY_{S1}:

$${dY}_{S 1} = \frac{\partial {Y}_{S 1}}{\partial {r}_{23}} {dr}_{23} + \frac{\partial {Y}_{S 1}}{\partial {r}_{13}} {dr}_{13} \qquad ( 11 )$$

Each partial derivative is the sensitivity of Y_{S1} to errors in the corresponding radius. The total weight (reciprocal of sensitivity) can then be calculated from:

$${w}_{1} = {[ {( \frac{\partial {r}_{23}}{\partial {Y}_{S 1}} )}^{2} + {( \frac{\partial {r}_{13}}{\partial {Y}_{S 1}} )}^{2} ]}^{1 / 2} \qquad ( 12 )$$

Similar expressions may be derived for the weights w₂ and w₃ in eq. 10.

As the numerical example below suggests, estimating Y_{S} from the weighted average of three independent intersections, results in improved accuracy compared to the 3VM. The impact of raw measurements errors is largely mitigated, since poor estimates from one voltage divider are typically compensated by the other two, hopefully characterized by lower sensitivity to errors. Sample admittance values where all three VDs are characterized by high sensitivity, are rare, and this broadens considerably the measurements range compared to the 3VM. Also, there are no degenerate points, as no sample admittance value can be simultaneously aligned with all three pairs of centers.

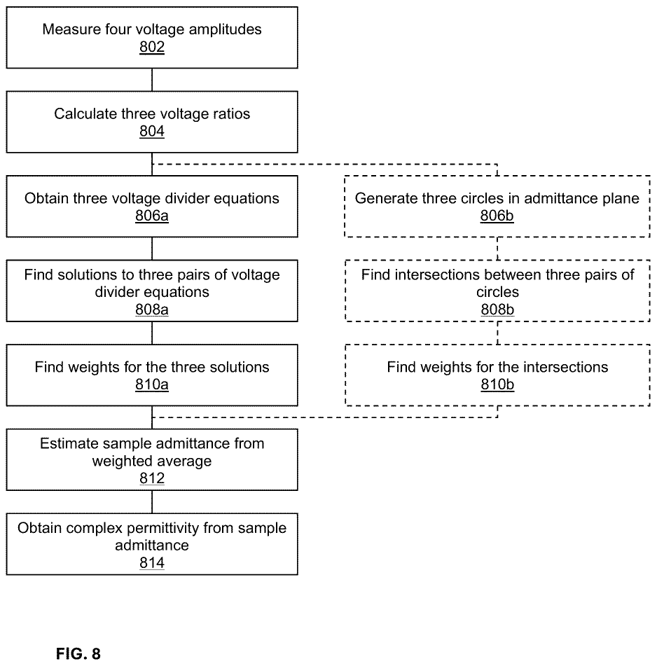

The calculations involved to predict complex permittivity from four voltage measurements are summarized in the flow chart illustrated in FIG. 8. The four-voltmeter method proceeds through the following acts: (1) four voltage amplitudes are measured, as indicated in block 802; (2) three voltage ratios are calculated from them, as indicated in block 804; (3) three corresponding voltage divider equations are obtained, whose parameters are known from the reference components, as indicated in block 806a; (4) three solutions (Y_{S1}, Y_{S2}, and Y_{S3}) of three pairs of VDEs are found, as indicated in block 808a; (5) a weight is found for each solution using eq. 12 and similar formulas, as indicated in block 810a; (6) Y_{S} is estimated from the weighted average of Y_{S1}, Y_{S2}, and Y_{S3} using eq. 10, as indicated in block 812; and (7) the complex permittivity η is obtained from Y_{S} using an appropriate model for the sample admittance, such as eq. 2 or 3, as indicated in block 814. These acts can be carried out using a computing device (e.g., a microcontroller) specially configured to receive and process the amplitude signals from the three VDs.

As stated earlier, a geometrical interpretation of the 4-voltmeter method also offers a convenient and equivalent way to solve voltage divider equations. For example, actions 806 through 810 listed above can be performed using geometric analysis, wherein solving a pair of equations is equivalent to finding the intersection of two circles, and actions 1-2 and 6-7 (blocks 802, 804, 812, and 814) would remain the same. Thus, the alternative actions may include: (3) generating (e.g., drawing) three circles in the admittance plane, whose centers and radii are known from reference components and voltage ratios, as indicated in block 806b; (4) finding three intersections (Y_{S1}, Y_{S2}, and Y_{S3}) between three pairs of circles, as indicated in block 808b; and (5) finding a weight for each intersection using eq. 12 and similar formulas, as indicated in block 810b. The weighted average of the intersections can be treated equivalently to the solutions of block 810a, so sample admittance can be estimated from the weighted average of the intersections, as shown in block 812, and complex permittivity can be obtained from the sample admittance, as shown in block 814.

### Numerical Example

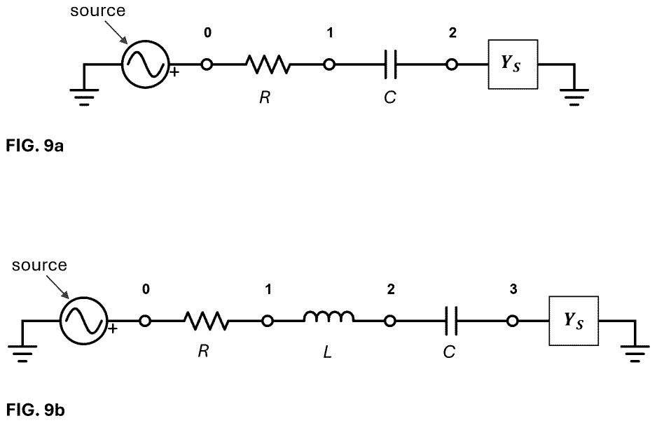

The benefits of the 4VM may be appreciated with a practical example. FIGS. 9a and 9b show a possible embodiment of the 3VM and of the 4VM, respectively. Except for the inductor L in the FIG. 9b, the two circuits are identical. For this numerical test, R=20Ω, C=60 pF, and L=60 nH. Both circuits operate at 100 MHz. In both cases, the sample is a hypothetical porous medium, with water content varying from 0 to 1 (correspondingly, ε varies from 1 to 80), while the conductivity of the water phase (σ_{w}) is 0, 1, 2, 3, 4, and 5 dS/m. The conductivity of the sample (σ) is obtained through the simple mixing model below:

$$\frac{σ}{{σ}_{w}} = \frac{ε - 1}{{ε}_{w} - 1} \qquad ( 13 )$$

where the water permittivity, ε_{w}=80. Complex permittivity is calculated from ε and σ according to eq. 1, while the low frequency model (eq. 2) is chosen for the sample admittance, with C₀=1 pF.

For each sample permittivity, it is possible to predict the response, i.e. the voltage at each node, of both circuits. This is known as the direct problem. Calculating permittivity from voltages (as in ordinary measurements), represents the inverse problem. In this exercise, the direct problem is solved for each sample, and for both circuits. Then, the inverse problem is solved, in an attempt to recover the original permittivity values from three (3VM) or four (4VM) voltages. In doing so, a random error of magnitude up to +/−1 mV (a relatively small value) is added to each voltage. Such incorrect voltages lead to incorrect estimates of Y_{S} and corresponding permittivity values. From these errors, one can assess and compare the sensitivity to raw measurements errors displayed by the two methods.

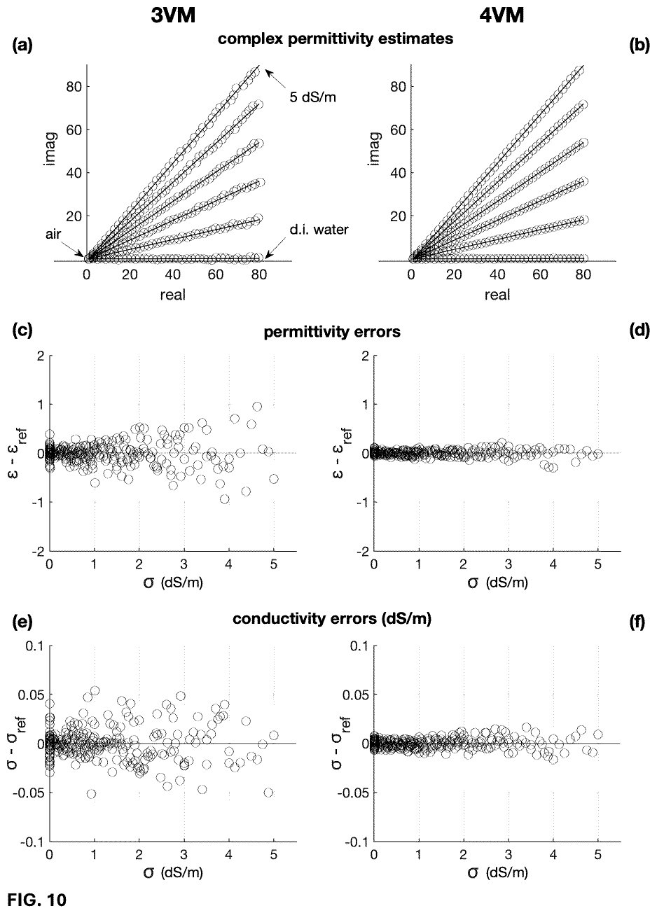

FIG. 10 compares the errors observed with two circuits in FIG. 9. FIGS. 10a and 10b show the estimated complex permittivity (circles), along with the original values (solid lines) for all samples. Errors (i.e. deviations from the solid lines) are evident for the 3VM (FIG. 10a), whereas they are hardly visible for the 4VM (FIG. 10b). Despite the incorrect voltages, the 4VM predicts nearly exact values of permittivity. This results from predicting Y_{S} as the weighted average of three independent estimates (Y_{S1}, Y_{S2}, and Y_{S3}). Each estimate is as flawed as the ones from the 3VM, since both circuits are subject, on average, to the same random errors in voltage. Their weighted average, however, is more accurate than each individual estimate, as the three errors tend to cancel out.

Errors in complex permittivity (η) can be broken down into errors in dielectric (ε) and conductivity (σ) values. Dielectric errors are shown in FIGS. 10c and 10d (respectively for the 3VM and 4VM), whereas conductivity errors are shown in FIGS. 10e and 10f (3VM and 4VM). The 4VM produces much smaller errors for ε and σ, compared to the 3VM. In this test, the root mean square error for the 4VM was about three times smaller than that observed for the 3VM. Therefore, the 4VM appears to be a lot more robust against voltage errors, and about three times more accurate than the 3VM.

### Calibration

Another aspect of the present disclosure relates to a method to calibrate complex dielectric sensors based on the four-voltmeter method. The 4VM relies on a physically based model to calculate sample admittance (Y_{S}) from voltage amplitudes, and then complex permittivity (η) from Y_{S}. The model involves numerous parameters, which typically are found empirically, i.e. through calibration. The parameters involved in the first step (from voltages to Y_{S}) are herein referred to as circuit parameters (as they characterize the reference components in the circuit), whereas the parameters in the second step (from Y_{S} to η) are herein referred to as sample parameters, as they are involved in the sample admittance model.

The calibration process typically amounts to testing a sensor in several standard materials of known (reference) values of permittivity. The number of standards should be greater than the number of parameters one wishes to determine. Starting from an initial guess, the parameters are iteratively adjusted (optimized) until the difference between calculated (η) and reference values (η_{ref}) is minimized. This is known as the objective function and can be expressed for example as:

$$F = \sum \vert η - {η}_{ref} \vert \qquad ( 14 )$$

where the sum extends to all samples.

In eq. 14, both circuit and sample parameters are involved in the calculation of η. This typically results into a lot of parameters to be optimized at once. And, as observed earlier, calibrations become problematic (and costly) as the number of parameters grows. This is due to computational complexity, and lack of standard materials.

This is where the three independent estimates of Y_{S} produced by the 4VM became particularly valuable. As observed earlier, the three estimates (Y_{S1}, Y_{S2}, and Y_{S3}) coincide for exact circles. That is, for exact values of centers and radii, or equivalently, circuit parameters and voltage ratios. Therefore, and assuming that voltage ratios are correct, the coincidence of those three estimates may be used as a condition that the circuit parameters must satisfy to be exact. This permits to introduce a second objective function (D), which could be defined, for example, as an average distance between the three estimates:

$$D = \sum \sqrt{{\vert {Y}_{S 1} - {Y}_{S 2} \vert}^{2} + {\vert {Y}_{S 1} - {Y}_{S 3} \vert}^{2} + {\vert {Y}_{S 3} - {Y}_{S 2} \vert}^{2}} \qquad ( 15 )$$

When the three estimates coincide, the distance D would be zero, evidently. Therefore, the circuit parameters can be found by imposing that D be minimum. The optimization proceeds by iteration, as in the traditional process, just using a different objective function.

A fundamental observation is that the actual Y_{S} (or η) values play no role in the calculation of D. As a result, the optimization can be performed using materials whose permittivity need not be known. Thus, any suitable material may be used for testing, covering a wide range of electrical properties, with no concern for their actual permittivity values. Loads (i.e. Y_{S1}, Y_{S2}, and Y_{S3} triplets) could also be realized electronically, e.g. by connecting the electrodes to some passive components of unknown values. This may significantly reduce the calibration costs as compared to traditional methods.

In various embodiments, at least one reference value may be beneficially used for a correct calibration. This is a consequence of D being agnostic to the true Y_{S} values. For example, if all points in FIG. 7a were rotated around the origin by an arbitrary angle, D would be unaffected. As a result, the three centers (and the corresponding circuit parameters) are determined only up to a complex constant, and one reference point in the admittance plane is necessary to determine their correct values. Such reference point could be obtained from a known permittivity (if the sample parameters are known), or electric load, or internal component.

A second observation, also fundamental, is that the sample parameters are not involved in the calculation of D. As a result, circuit parameters can be determined independently of the sample parameters, which need not be known at the time of calibration. Once the circuit parameters are found, a second optimization may be carried out to determine some or all sample parameters. This would be done through traditional methods, i.e. by testing the sensor in standard materials, and minimizing the function F in eq. 14.

The availability of three independent estimates of Y_{S} thus permits to break the calibration in two separate optimization processes, each involving a smaller number of parameters, and therefore much easier to perform. Moreover, the optimization of the circuit parameters requires only one reference value, while all other loads may be unknown. The advantages of such approach can hardly be overestimated. Compared to the 3VM, calibrating sensors based on the 4VM is sound, simple, and considerably less costly.

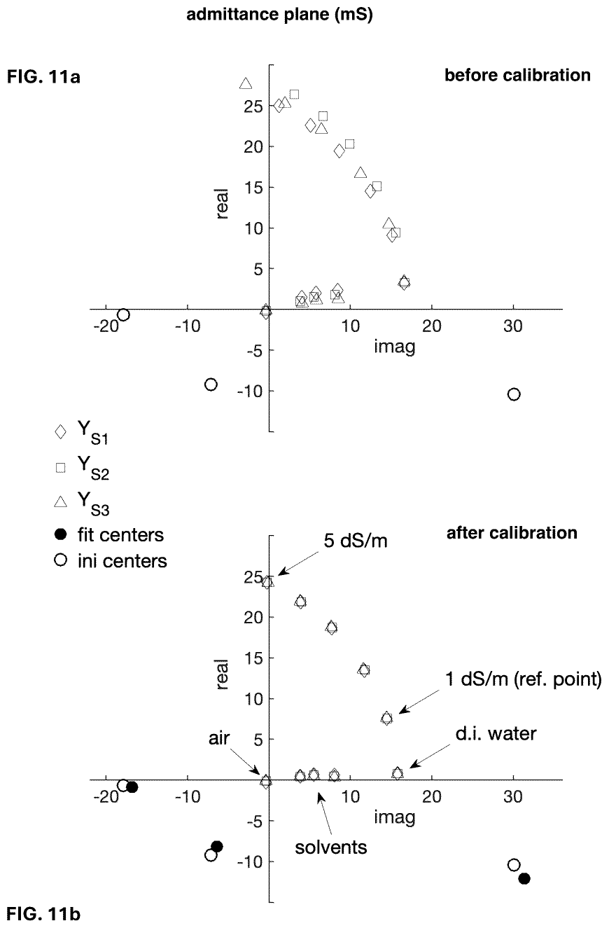

As a practical example of circuit parameters' optimization, FIGS. 11a and 11b show some results obtained for a 4VM prototype sensor. Voltage measurements were taken for several sample materials, including air, water solutions with σ_{w}=0, 1, 2, 3, 4, and 5 dS/m, and three non-conductive solvents (ethanol, methanol and dimethyl sulfoxide). The permittivity of these samples (although known) was not used in the calibration, except for the water solution with σ_{w}=1 dS/m, which was chosen as a reference point in the admittance plane.

Approximate values for the circuit parameters were obtained from the nominal values for the reference components. The corresponding centers are not exact, as nominal values deviate from actual behaviors. As a result, when these centers are used (along with the measured voltage ratios) to draw the circles, the three intersections (Y_{S1}, Y_{S2}, and Y_{S3}) do not coincide. This is the case shown in FIG. 11a.

Starting from these approximate values, the parameters are iteratively adjusted until the objective function D in eq. 15 is minimized (with a constraint imposed by the reference point, 1 dS/m solution). The centers so optimized are shown in FIG. 11b (where they are labelled as “fit centers”), along with the initial values (“ini. centers”). Using the fit centers to draw the circles, the three independent estimates of Y_{S} are very nearly coincident for all samples. There is only one set of center points that can satisfy this condition, and this guarantees the correctness of the optimization results. Except for one reference point, the circuit parameters were obtained with no knowledge of the samples' permittivity values.

### Self-Diagnosis

Another aspect of the present disclosure relates to a method to diagnose a complex dielectric sensor based on the 4VM. During their lifetime, dielectric sensors may be tested from time to time to verify their well-functioning and accuracy. Typically, this is done by testing the sensor in one or more standard materials and comparing measurements against reference values. Besides being costly, this procedure is not feasible while the sensor is deployed, for the user may have no access to the sensor, nor control over the sample material the sensor is in contact with.

The 4VM offers two possible methods to diagnose sensors remotely, that is, without performing ad hoc experiments, with no knowledge of the sample material the sensor is in contact with, and with no intervention from the user. This is a valuable feature, which permits to diagnose 4VM sensors, for example, while deployed in remote locations.

A first test can be performed by comparing the three independent estimates of sample admittance (Y_{S1}, Y_{S2}, and Y_{S3}). For a well-functioning sensor, and regardless of the sample, the three estimates should have roughly the same value, as illustrated in FIG. 11b. After all, the sensor was calibrated by imposing that the mean difference among the three values (D in eq. 15) be as small as possible. Then, a threshold value for D can be set, above which the sensor is deemed not to be working properly. This test requires no knowledge of the sample permittivity, or the related admittance value.

A second test can be performed as follows. In ordinary measurements, the three VDEs (eqs. 7, 8, and 9) are treated as a system of three equations in two unknowns (real and imaginary parts of Y_{S}). As explained above, this leads to three independent estimates of Y_{S}. Alternatively, the extra equation can be used to estimate a third, unknown quantity. That is, the VDEs can be treated as a system of three equations in three unknowns. The third unknown could be any (real) parameter characterizing the sensor for which an expected, or reference value is known. Indicating such real parameter as Tₚ (test parameter), the system of three VDEs can then be solved for three unknowns: real (Y_{S}), imag (Y_{S}), and Tₚ. Thus, Tₚ can be calculated, along with Y_{S}, from the usual four voltage measurements. Estimated Tₚ can then be compared against a reference value. The difference between the two may offer a measure of the accuracy of the sensor, and the sensor can be deemed malfunctioning whenever such difference exceeds a predetermined threshold value. Like for the first test, no information about the sample is necessary.

While this procedure is general, and could be applied to any real parameter, the math becomes particularly simple if Tₚ is chosen as the reference component in the circuit directly connected to the voltage source (indicated as Y_{A} in FIG. 6b). Inspection of the VDEs reveals, in fact, that Y_{A} plays no role in the first two equations (7 and 8), the only unknown being complex Y_{S}. Therefore, equations 7 and 8 can be solved for Y_{S}. Upon substitution of this value, equation 9 can then be solved separately for Y_{A}. Note that Y_{A} is complex in general, so Tₚ may represent either its real or its imaginary part. Purely resistive (e.g., a resistor) or purely reactive components (e.g., a capacitor or inductor) would be fully characterized by Tₚ. Also, Y_{S} so estimated corresponds to the intersection between circles Γ₂₃ and Γ₁₃ in FIG. 7a and was earlier identified as Y_{S1}. This is the only estimate of Y_{S} computed while diagnosing, as the extra information available with the 4VM is used to estimate Tₚ, rather than three independent Y_{S} values.

Equation 9 is amenable to a geometrical interpretation, which suggests a closed form solution for it. Multiplying both sides for Z_{S} and Z₀₃ (reciprocal of Y_{S} and Y₀₃, respectively), the eq. 9 can be rewritten as:

$${g}_{03} \vert {Z}_{S} \vert = \vert {Z}_{S} + {Z}_{03} \vert \qquad ( 16 )$$

where g₀₃=[V₀/V₃]. This equation is equivalent to eq. 9, just expressed in the impedance, rather than in the admittance domain. With reference to FIG. 6b, Z_{S}+Z₀₃ evidently equals Z₀, the (input) impedance at node 0. And since Z₀=Z₁+Z_{A}, where Z₁ is the input impedance at node 1, while Z_{A}=1/Y_{A}, eq. 16 becomes:

$${g}_{03} \vert {Z}_{S} \vert = \vert {Z}_{1} + {Z}_{A} \vert = \vert {Z}_{0} \vert \qquad ( 17 )$$

The only unknown in the equation above is Z_{A}. Once Z_{S} is found (by solving equations 7 and 8), complex Z₁ is obtained from: Z₁=Z_{B}+Z_{C}+Z_{S}, with obvious meaning of the symbols.

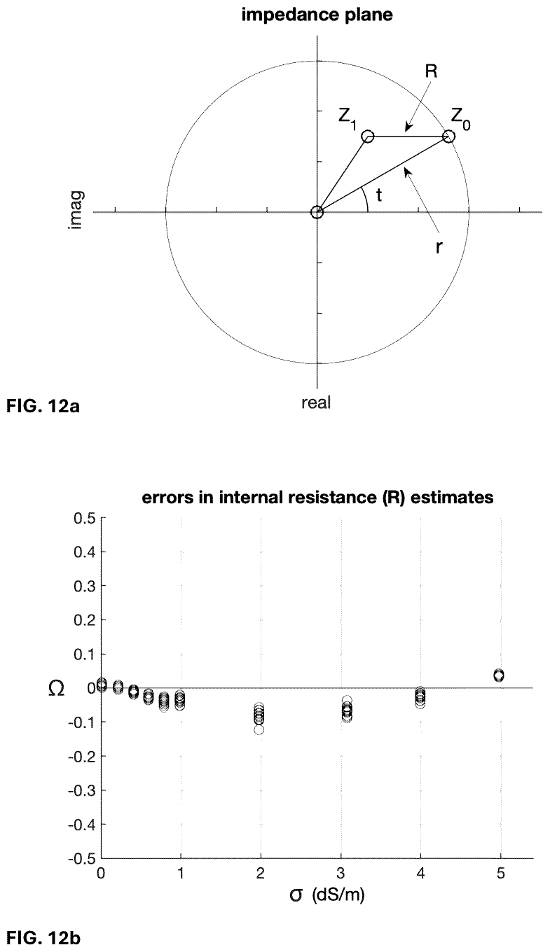

Equation 17 informs us that the sum of the complex quantities Z₁ and Z_{A} has magnitude g₀₃|Z_{S}|. These quantities are plotted in the impedance plane in FIG. 12a for a special case, where Z_{A}=R is a real number, i.e. for a pure resistor as first component. Z₀ can be found in this case from the intersection between a circle (with center in the origin and radius g₀₃|Z_{S}|) and the horizontal line passing through Z₁. Then, R is obtained very simply from the horizontal distance between Z₀ and Z₁. The formula is:

$$R = r cos ( t ) - {Z}_{1 x}$$

$$with : r = {g}_{03} \vert {Z}_{S} \vert$$

$$t = a sin ( \frac{{Z}_{1 y}}{r} )$$

$${Z}_{1} = {Z}_{1 , x} + i {Z}_{1 , y}$$

An analogous formula could be derived for a pure capacitor as first component, whose value would be obtained from the vertical distance between Z₀ and Z₁. Whether a resistance or a capacitance, the test parameter so calculated is compared to some reference value, which permits to quantify the accuracy of the sensor.

As a practical example, FIG. 12b shows test results from 20 prototype sensors submerged in several water solutions with conductivity from 0 to 5 dS/m. These are 4VM sensors, featuring a precision resistor as first component, of magnitude 60Ω. This internal resistance was estimated with the method above, and FIG. 12b shows the errors for all sensors and all samples. Estimates are in excellent agreement with the reference value (with errors less than 0.2%), indicating that the sensors are in working order, and that accuracy specifications are met.

### FINAL REMARKS

Aspects of the present disclosure relate to a complex dielectric sensor, an instrument capable of measuring the dielectric permittivity and the electrical conductivity of a generic material at once. These measurements find applications, for example, in agriculture, as the electric properties of soil are closely related to its moisture and solute concentration.

The sensor measures the complex admittance (Y_{S}) of a set of electrodes in contact with the sample material. For a given geometry of the electrodes, Y_{S} depends solely on the complex permittivity of the sample, which therefore can be inferred from it. Methods here disclosed to estimate complex Y_{S} rely on multiple, e.g., four, voltage amplitude measurements in a suitable circuit.

In one embodiment, three reference passive components in series are placed between a sinusoidal voltage source and the electrodes. Voltage amplitudes are measured at the four ensuing nodes through generic RMS voltmeters. Three independent voltage ratios can be identified from them, each being related to Y_{S} through a voltage divider equation (VDE). This leads to a set of three equations in two unknowns (real and imaginary part of Y_{S}), one more equation than strictly necessary to calculate Y_{S}. The extra information can be used to enhance the performance of the sensor in at least three ways.

There are three combinations of two equations (in two unknowns) among the available three VDEs. One can solve each combination and obtain three independent estimates of Y_{S}. Some estimates are more reliable than others, i.e. are less sensitive to measurements errors. So, a weight is assigned to each, and the final Y_{S} value is estimated from their weighted average. This leads to more accurate and more robust measurements, relative to the traditional 3VM (up to a factor of 3, as per numerical analysis). Consequently, it widens the range of permittivity values that can be measured reliably with the 4VM.

Rather than obtaining three independent estimates of Y_{S}, it is possible to use the extra equation to estimate one (real) parameter characterizing the circuit. For example, the resistance of a high-quality resistor chosen as a reference component could be measured. The agreement between measured and reference values offers a measure of the sensor's accuracy. Thus, it can be used to diagnose the sensor. The test requires no knowledge of the sample admittance, nor of the corresponding complex permittivity, and can be performed with the sensor deployed. This is a very useful feature, particularly for remote applications, where the well-functioning of the sensor may be in question.

A third benefit of the 4VM derives again from the three independent estimates of Y_{S}. For a perfectly characterized sensor, and error-free voltage measurements, the three estimates for a generic sample should coincide. This observation offers a criterium for estimating the parameters characterizing the circuit, which are involved, in fact, in Y_{S} calculations. If the number of samples is larger than the number of parameters one seeks to determine, the parameters can be found by imposing that the average distance among the three estimates of Y_{S} be minimum. The remaining parameters, those characterizing the relation between dielectric and admittance, are not involved in this optimization process. They can be found through a separate optimization, by imposing agreement between predicted and reference complex dielectric values. The condition on Y_{S} thus permits to break the calibration in two separate processes, which are computationally less challenging than optimizing all the parameters at once. Moreover, the first optimization requires no knowledge of the actual Y_{S}, nor of the corresponding permittivity values. In other words, reference values for the complex permittivity are no longer necessary for optimizing the circuit parameters. The advantage of such method can hardly be overestimated, as the limited availability of dielectric standards typically results in high calibration costs.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A complex dielectric sensor, comprising:
at least two electrodes configured to contact a sample material;
a voltage source configured to output a sinusoidal signal at a frequency;
a first reference component electrically connected to the voltage source;
a second reference component electrically connected in series with the first reference component;
a third reference component electrically connected in series with the second reference component, wherein at least one electrode of the at least two electrodes is electrically connected in series with the third reference component and remaining electrodes of the at least two electrodes are connected to a ground potential;
a set of electric connections including a first connection between the voltage source and the first component, a second connection between the first component and the second component, a third connection between the second component and the third component, and a fourth connection between the third component and the at least one electrode; and
a set of one or more voltmeters configured to measure amplitudes of voltage signals at the first, second, third, and fourth connections.

2. The complex dielectric sensor of claim 1, wherein the sensor is connected to a computing device configured to measure the complex permittivity (η) of the sample material by:
calculating an electric admittance (Y_{S}) of the at least two electrodes from the amplitudes of the voltage signals measured at the first, second, third, and fourth connections; and
calculating a complex permittivity (η) of the sample material from the electric admittance (Y_{S}) based on a known relation between the electric admittance (Y_{S}) and the complex permittivity (η) for a specific frequency and geometry of the electrodes.

3. The complex dielectric sensor of claim 2, wherein the electric admittance (Y_{S}) is calculated by:
combining the amplitudes of the voltage signals at the first (V₀), second (V₁), third (V₂), and fourth (V₃) connections into a first voltage ratio (V₂/V₃), a second voltage ratio (V₁/V₃), and a third voltage ratio (V₀/V₃);
identifying, from the first voltage ratio, a first voltage divider and a first voltage divider equation (VDE1);
identifying, from the second voltage ratio, a second voltage divider and a second voltage divider equation (VDE2);
identifying, from the third voltage ratio, a third voltage divider and a third voltage divider equation (VDE3);
calculating a first estimate of sample admittance (Y_{S1}) by solving the first and the second voltage divider equations together (VDE1 and VDE2);
calculating a second estimate of sample admittance (Y_{S2}) by solving the second and the third voltage divider equations together (VDE2 and VDE3);
calculating a third estimate of sample admittance (Y_{S3}) by solving the first and the third voltage divider equations together (VDE1 and VDE3);
calculating a weight for each of said three estimates of sample admittance (Y_{S1}, Y_{S2}, and Y_{S3}), based on the respective sensitivity to raw measurements errors;
calculating a final estimate of the sample admittance (Y_{S}) from a weighted average of said three independent estimates, using said three weights.

4. The complex dielectric sensor of claim 3, wherein the sensor is further configured to estimate circuit parameters characterizing the first, second, and third reference components by:
measuring the amplitudes of the voltage signals at the first, second, third, and fourth connections (V₀, V₁, V₂, and V₃) for different samples;
calculating three voltage ratios from said four voltage amplitude;
obtaining three voltage divider equations (VDEs) based on the three voltage ratios;
calculating, for each sample, three independent estimates of sample admittance (Y_{S1}, Y_{S2}, and Y_{S3}) by solving three pairs of the three VDEs and by using initial guess values for the circuit parameters;
optimizing the circuit parameters by iteratively adjusting values of the circuit parameters and calculating the three independent estimates of sample admittance at each iteration, until an average distance between the three independent estimates of sample admittance (Y_{S1}, Y_{S2}, and Y_{S3}) is minimum, on average, for all samples of the different samples.

5. The complex dielectric sensor of claim 4, wherein at least one reference value of admittance (Y_{S}) is known in said optimization process, while the Y_{S} values corresponding to all other samples need not be known.

6. The complex dielectric sensor of claim 3, wherein the sensor is further configured to be diagnosed by:
measuring the amplitudes of the voltage signals at the first, second, third, and fourth connections (V₀, V₁, V₂, and V₃);
calculating three independent estimates of sample admittance (Y_{S1}, Y_{S2}, and Y_{S3}) from three voltage ratios (V₂/V₃, V₁/V₃, and V₀/V₃);
determining an average distance among the three independent estimates of sample admittance (Y_{S1}, Y_{S2}, and Y_{S3}); and
assessing the well-functioning of the sensor based on said average distance, the distance being zero for ideal sensors.

7. The complex dielectric sensor of claim 6, wherein no knowledge of the electric properties of the sample material is used to diagnose the sensor, and therefore said diagnosis can be performed remotely.

8. The complex dielectric sensor of claim 3, wherein the sensor is further configured to be diagnosed by:
choosing a test parameter (Tₚ) among the parameters characterizing the sensor, for which an expected value is known;
determining an estimated value of the test parameter (Tₚ) by solving a system of three voltage divider equations (VDE1, VDE2 and VDE3) for three unknowns, the three unknowns including a real part of the sample admittance (Y_{S}), an imaginary part of the sample admittance (Y_{S}), and the test parameter (Tₚ);
assessing accuracy of the sensor based on a difference between the expected value and the estimated value of the test parameter (Tₚ).

9. The complex dielectric sensor of claim 8, wherein the expected value is known from calibration of the sensor.

10. The complex dielectric sensor of claim 8, wherein no knowledge of the electric properties of the sample material is used to diagnose the sensor.

11. The complex dielectric sensor of claim 1, further comprising a computing device configured to predict a complex permittivity (η) of the sample material based on the amplitudes of the voltage signals at the first, second, third, and fourth connections.
